(19) United States
(12) Patent Application Publication
(10) Pub. No.: US 2012/0102250 A1
(43) Pub. Date: Apr. 26, 2012

(54) BUS SYSTEM

(75) Inventors: Jaegeun YUN, Hwaseong-si (KR); Bub-chul JEONG, Yongin-si (KR)

(73) Assignee: SAMSUNG ELECTRONICS CO., LTD., Suwon-si (KR)

(21) Appl. No.: 13/272,934

(22) Filed: Oct. 13, 2011

(30) Foreign Application Priority Data
Oct. 20, 2010 (KR) 10-2010-0102557

(51) Int. Cl. G06F 13/00

(52) U.S. Cl. 710/110

(57) ABSTRACT

A bus system includes a master transferring write data internally via a first write data channel and an address internally via a first address channel; and a bus transferring the write data and the address to a slave from the master via one channel.

### CROSS-REFERENCE TO RELATED APPLICATIONS

This application claims priority from Korean Patent Application No. 10-2010-0102557 filed Oct. 20, 2010, the entire contents of which is incorporated by reference herein.

### BACKGROUND

1. Field

Exemplary embodiments relate to a System-On-Chip (SOC) bus system.

2. Description of the Related Art

System-On-Chip (hereinafter, referred to as SOC) is a technique for integrating components of a complicated system with various functions into a single semiconductor chip. Needs for an Application Specific Integrated Circuit (ASIC) and an Application Specific Standard Product (ASSP) have been shifted into the SOC according to convergence trends of computers, communications, broadcastings, etc. Small and light Information Technology (IT) devices accelerate SOC-associated industries.

An SOC may include Intellectual Properties which perform specific functions. In general, Intellectual Properties may be interconnected with one another via a bus. The Advanced Microcontroller Bus Architecture (AMBA) protocol of the Advanced RISC Machine (ARM) company may be applied as an exemplary standard bus protocol for connecting and managing intellectual properties within the SOC. The AMBA protocol may include bus types such as Advanced High-Performance Bus (AHB), Advanced Peripheral Bus (APB), Advanced eXtensible Interface (AXI), etc. As the interface protocol of intellectual properties, the AXI may include multiple outstanding address functions, a data interleaving function, and the like.

As needs for high performance increase with mobile application processors, there is a trend that operating frequencies of a central processing unit (CPU) and cache controllers within the SOC increase up to several GHz. That is, data transfer amounts between intellectual properties increases, which results in an increase in the bandwidth of data transferred via a bus. That is, increased bus data width is provided. The number of wires in a bus may increase according to an increase in the bus data width.

### SUMMARY

One or more exemplary embodiments provide a bus system which includes a master transferring write data internally via a first write data channel and an address internally via a first address channel; and a bus transferring the write data and the address into a slave from the master via one channel.

According to an aspect of an exemplary embodiment, there is provided a bus system including: a master which is configured to transfer write data internally via a first write data channel and transfer an address internally via a first address channel; a slave; a bus which is configured to receive the write data and the address from the master and transfer the write data and the address received from the master to the slave via one channel.

According to an aspect of another exemplary embodiment, there is provided an operating method of a bus system including a master, a slave, and a bus connecting the master and slave. The operating method includes: receiving an address and write data to be sent to the slave from the master; determining whether the address can be transferred with at least part of the write data; if it is determined that the address can be transferred with the at least part of the write data, transferring the address and the part of the data together via a combined write channel; and if it is determined that the address can not be transferred with the at least one part of the write data, transferring the address and the write data separately via the combined write channel.

According to an aspect of another exemplary embodiment, there is provided a bus system including: a master which is configured to internally transfer write data and an address via a separate channels, and output the write data and the address; a slave which is configured to receives the write data and the address output by the master, and internally transfer the write data and the address via separate channels; and a bus which is configured to transfer the write data and the address output the master to the slave via a single integrated write channel.

### BRIEF DESCRIPTION OF THE DRAWINGS

The above and other aspects will become apparent from the following description with reference to the following figures, wherein like reference numerals refer to like parts throughout the various figures unless otherwise specified, and wherein:

FIG. 1 is a block diagram showing a bus system according to a first exemplary embodiment;

FIG. 2 is a diagram for describing a data storing function executed by a slave in FIG. 1;

FIG. 3 is a block diagram showing the case that a write address and the first write data are transferred together within the first burst;

FIG. 4 is a block diagram showing the case that a write address and the first write data are transferred within different bursts, respectively;

FIG. 5 is a diagram showing the configuration of data transferred via a merged write channel within the first burst in FIG. 3;

FIG. 6 is a table showing a byte number of write data transferred during one burst when transfer size data is expressed by 3 bits;

FIG. 7 is a diagram showing an address region assigned to a memory in FIG. 2;

FIG. 8 is a diagram showing the case that the first write data and a write address are sent together during one burst according to channel alignment information of FIG. 7;

FIG. 9 is a diagram showing the case that a write address and the first write data are sent during two bursts, respectively;

FIG. 10 is a flow chart for describing an operation where a write address and the first to third write data are transferred from a master bridge in FIG. 2;

FIG. 11 is a flow chart for describing a method of receiving data via a slave bridge in FIG. 2;

FIG. 12 is a block diagram showing a bus system according to a second exemplary embodiment; and

FIG. 13 is a diagram for describing an operation of transferring a write address and write data to a slave from a master in FIG. 12.

### DETAILED DESCRIPTION

Exemplary embodiments will be described hereinafter with reference to the accompanying drawings. The inventive concept may, however, be embodied in many different forms and should not be construed as limited to the exemplary embodiments set forth herein. Rather, these exemplary embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

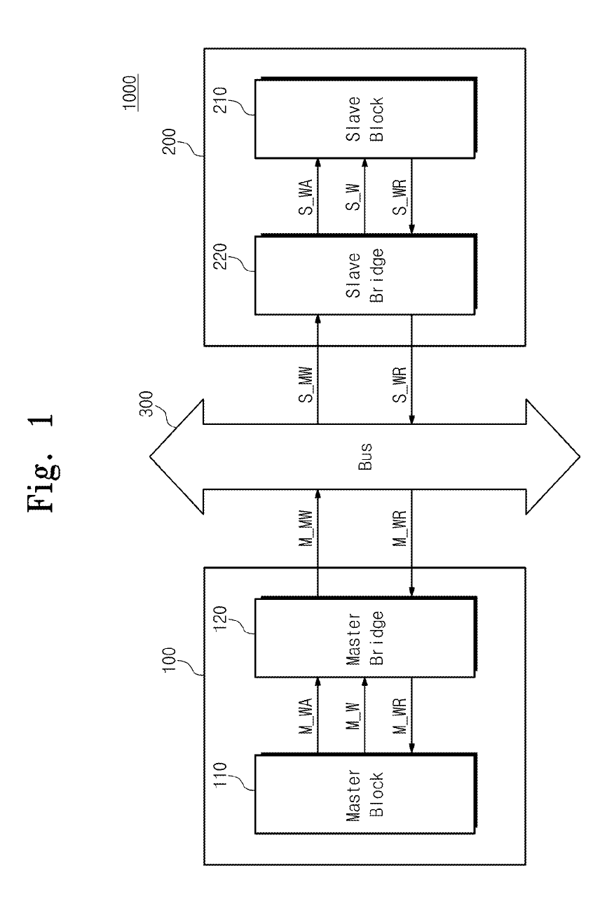

FIG. 1 is a block diagram showing a bus system according to a first embodiment.

Referring to FIG. 1, a bus system 1000 may include a master 100, a slave 200, and a bus 300. In FIG. 1, the bus system 1000 is illustrated which includes one master 100 and one slave 200. However, the master number and the slave number may be changed variously.

The master 100 may include a master block 110 and a master bridge 120. The master block 110 is connected with the master bridge 120 via a write address channel M_WA, a write data channel M_W, and a write response channel M_WR.

The master block 110 may generate a write address (not shown) and write data (not shown). The write address and the write data may be transferred via the write address channel M_WA and the write data channel M_W, respectively. That is, the master 100 internally transfers a write address via the write address channel M_WA. The master 100 internally transfers write data via the write data channel M_W. In an exemplary embodiment, the master block 110 and the master bridge 120 may communicate on the basis of the AXI protocol.

The master bridge 120 is connected with the bus 300 via a merged write channel M_MW. The master bridge 120 transfers a write address and write data to the bus 300 via the merged write channel M_MW. The master bridge 120 sends a write response signal received via the write response channel M_WR to the master block 110. Herein, the write response signal is a signal sent from the slave 200 when a transfer of write data is completed.

The master 100 may be a CPU, a microcontroller and a microprocessor, a digital signal processor, or the like. In case of a bus system for a mobile device, the master 100 may be application chip, image processing processor audio codec, mobile station modem, or the like.

Although not shown in FIG. 1, the master 100 can sent a request signal for accessing the slave 200 to the bus 300. If a grant signal is received from the bus 300, the master 100 sends a write address for accessing to the slave 200 to the bus 300 according to a granted bus ownership.

As not illustrated in FIG. 1, the master 100 can be connected with the bus 300 via a read address channel (not shown) and a read data channel (not shown). In order to receive data from the slave 200, the master 100 may send a read address to the slave 200 via the read address channel. The master 100 may receive data sent from the slave 200 via the read data channel.

The slave 200 may include a slave block 210 and a slave bridge 220. The slave block 210 is connected with the slave bridge 220 via a write address channel S_WA, a write data channel S_W, and a write response channel S_WR.

The slave bridge 220 is connected with the bus 300 via a merged write channel S_MW and a write response channel S_WR. The slave bridge 220 receives a write address and write data from the bus 300 via the merged write channel S_MW. The slave bridge 220 may send the write address and the write data to the slave block 210 via the write address channel S_WA and the write data channel S_W, respectively. That is, the slave 200 internally transfers the write address via the address channel S_WA and the write data via the write data channel S_W, respectively. In an exemplary embodiment, the slave block 210 and the slave bridge 220 communicate on the basis of the AXI protocol.

The slave block 210 stores write data at a region corresponding to a write address. When storing of write data is completed, the slave block 210 generates a write end signal as a write response signal. The slave bridge 220 transfers a write response signal received via the write response channel S_WR into the bus 300. In an exemplary embodiment, the slave block 210 may generate a write end signal when transferring of write data and address is completed.

The bus 300 may include a decoder (now shown). The decoder decodes a write address received from the master bridge 120. The bus 300 may connect the merged write channels M_MW and S_MW. As a result, if data is transferred to the slave 200 from the master 100, the master bridge 120 and the slave bridge 220 may be connected via the merge write channel M_MW, the bus 300, and the merged write channel S_MW.

In accordance with an exemplary embodiment, the bus 300 connects the merged write channels M_MW and S_MW based on a write address received from the master 100. The bus 300 transfers a write address and write data, received from the master 100, to the slave 300 via the merged write channels M_MW and S_MW. That is, the write address and the write data may be sent to the slave 200 from the master 100 via one channel.

The master 100 transfers data bits by a burst unit. Herein, the burst means an operation of transferring data in high speed via one exclusive channel. For example, the master 100 can send data bits during one burst in synchronization with a clock signal (not shown) provided to the bus system 1000.

The merged write channels M_MW and S_MW may be formed of a plurality of wires through which data bits are transferred every burst. At this time, each of the merged write channels M_MW and S_MW may have a data width. In the event that write data to be transferred is not sent by one burst, it may be sent over plural bursts.

The number of bursts needed for transferring of write data may be changed according to a size of write data transferred from the master 100. Since an address region of the slave bridge 220 can be expressed by constant bits, a size of a write address transferred from the master 100 may be constant.

In accordance with the exemplary embodiment, the master bridge 120 may determine whether a write address and write data can be transferred within one burst. If it is determined that a write address and write data can be transferred within one burst, the master bridge 120 may send a write address and write data together within one burst.

If it is determined that a write address and write data can not be transferred within one burst, the master bridge 120 may send a write address in the first burst and write data in the second burst, respectively.

The bus 300 may include an arbiter and a decoder although not illustrated in FIG. 1. The bus 300 may be a multi-layer bus. The arbiter may grant the right such that one master uses a bus once, and may be configured to arbitrate the master 100 and the slave 200. For example, if a request signal for accessing to the slave 200 is received from the master 100, the bus 300 may send a grant signal to the master 100. The decoder decodes a write address received from the master 100, and the bus 300 connects the merged write channels M_MW and S_MW based on the decoded result.

The write data width of the bus 300 may be identical to that of the respective merged write channels M_MW and S_MW. That is, if the merged write channels M_MW and S_MW are connected via the bus 300, the write data width of the bus 300 may be identical to that of the respective merged write channels M_MW and S_MW. For example, it is assumed that the bus 300 is designed to have the write data width of 128 bits. With this assumption, the data width of the respective merged write channels M_MW and S_MW may be designed to have the 128-bit width. That is, if the merged write channels M_MW and S_MW are connected via the bus 300, the merged write channels M_MW and S_MW and the bus 300 may constitute an integrated write channel.

According to the above-described embodiment, it is possible to transfer a write address and write data from the master 100 to the slave 200 via the merged write channels M_MW and S_MW. The integration of the bus system 1000 may be improved as compared with the event that a write address and write data are sent via different channels.

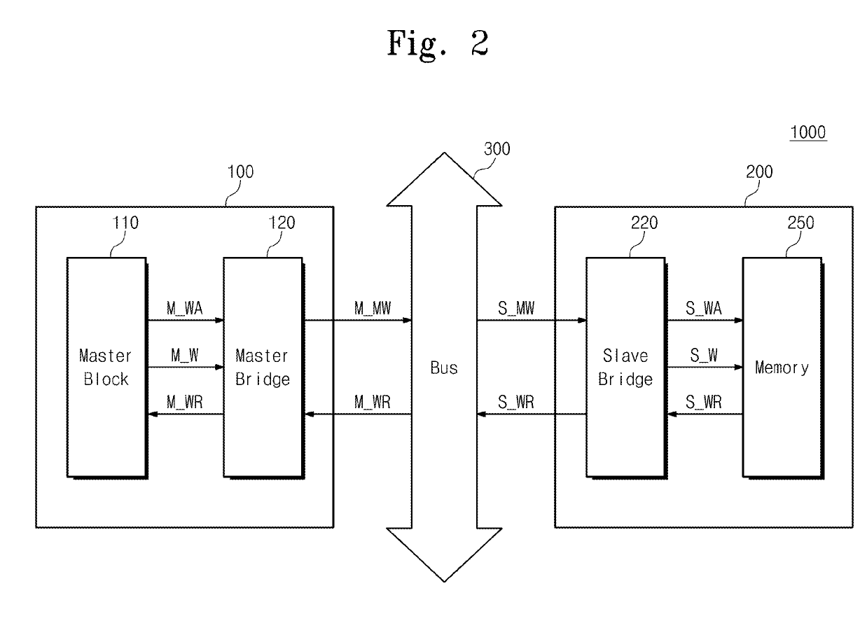

FIG. 2 is a diagram for describing a data storing function executed by a slave in FIG. 1.

Referring to FIG. 2, a slave 200 may include a memory 250. The memory 250 may receive a write address and write data from a slave bridge 220. The memory 250 may store the received write data in a predetermined region based on the received write address.

In an exemplary embodiment, the memory 250 may include a memory core (not shown) having a memory cell array and a memory controller (not shown) controlling the memory core. The memory controller may execute an interface function between the slave bridge 220 and the memory 250.

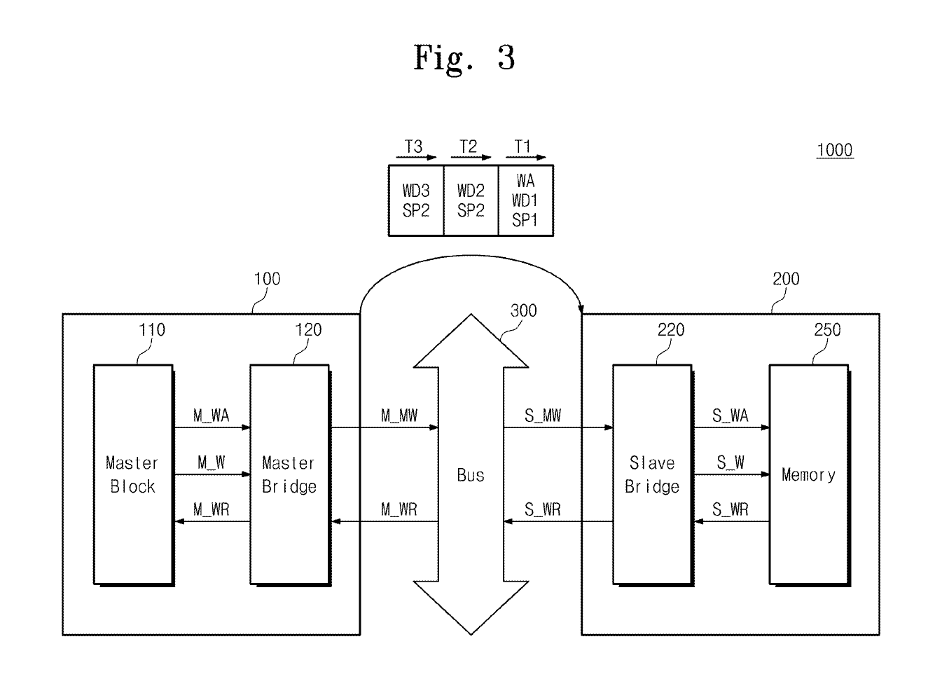

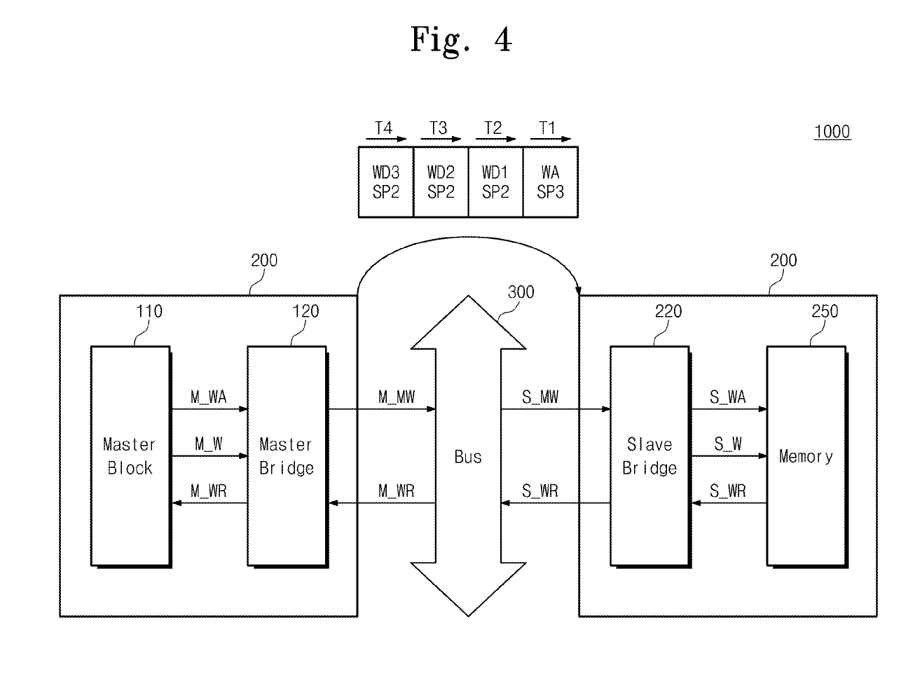

FIGS. 3 and 4 illustrate cases that a write address WA and the first to third write data WD1 to WD3 are transferred via merged write channels M_MW and S_MW and a bus 300 illustrated in FIG. 2.

FIG. 3 is a block diagram showing the case that a write address and the first write data are transferred together within the first burst.

A master block 110 may generate a write address WA and the first to third write data WD1 to WD3. The write address WA and the first to third write data WD1 to WD3 are sent to a master bridge 120 via channels M_WA and M_W, respectively. The write address WA and the first to third write data WD1 to WD3 may be sent to a slave bridge 220 via one channel.

Based on a size of the write address WA and a size of the first write data WD1, the master bridge 120 determines whether the write address WA and the first write data WD1 can be sent together in the first burst T1. The write address WA and the first write data WD1 may be sent together according to the determination result. If it is determined that the write address WA and the first write data WD1 can not be sent together in the first burst T1, they are sent in different bursts, respectively.

The master bridge 120 may send a separator in each burst. The separator may be used to distinguish whether both write address and write data are sent, whether only a write address is sent, and whether only write data is sent. For example, a two-bit separator may be used to distinguish such cases.

The master bridge 120 may send write address WA and the first write data WD1 along with the first separator SP1 in the first burst T1. The first separator SP1 is used to indicate that transferred data includes a write address WA and the first write data WD1.

The slave bridge 220 may receive the write address WA, the first write data WD1, and the first separator SP1 via a merged write channel S_MW in the first burst T1. The slave bridge 220 may determine whether received data includes a write address WA and write data, based on the first separator SP1.

The second write data WD2 and the second separator SP2 are sent in the second burst T2. The third write data WD3 and the second separator SP2 are sent in the third burst T3. Since data transferred during the second and third bursts T2 and T3 is write data, the same separator SP2 is sent in the second and third bursts T2 and T3. That is, the separator SP2 sent in the second and third bursts T2 and T3 may indicate that transferred data is write data. The slave bridge 220 may determine data received in the second and third bursts T2 and T3 to be write data, based on the separator SP2. In an exemplary embodiment, end of file information can be added to the write data WD3. In this case, the slave 200 may determine whether the third burst T3 is the last burst, based on the end of file information. The slave 200 may store the first to third write data WD1 to WD3 in a region corresponding to the write address WA, according to the determination result.

FIG. 4 is a block diagram showing the case that a write address and the first write data are transferred within different bursts, respectively. In FIG. 4, there is illustrated the case that a write address WA and the first write data WD1 are not transferred together within one burst.

A write address WA is sent in the first burst T1. At this time, the third separator SP3 may be sent together in the first burst T1. The third separator SP3 is used to indicate that transferred data is a write address WA. A slave bridge 220 may determine transferred data to be a write address WA, based on the third separator SP3. The write address WA may be transferred to a memory 250.

The first to third write data WD1 to WD3 may be sent in the second to fourth bursts T2 to T4, respectively. Further, the second separator SP2 may be sent in the second to fourth bursts T2 to T4, respectively. The slave bridge 220 may determine transferred data transferred respectively in the second to fourth bursts T2 to T4 to be write data, based on the second separator SP2. The first to third write data WD1 to WD3 may be sent to the memory 250. The first to third write data WD1 to WD3 may be stored in a predetermined region of the memory 250, based on the write address WA.

Unlike a merged write channel, in the event that write data and a write address are sent to the master 100 from the slave 200 via different channels, there is required identification information for a correspondence between a write address and write data at a slave side. That is, in order to search write data corresponding to a write address, identification information is required with respect to a write address and write data, respectively. In accordance with an exemplary embodiment, since a write address and write data are sent to the slave 200 via the same channel, the master 100 does not send separate identification information.

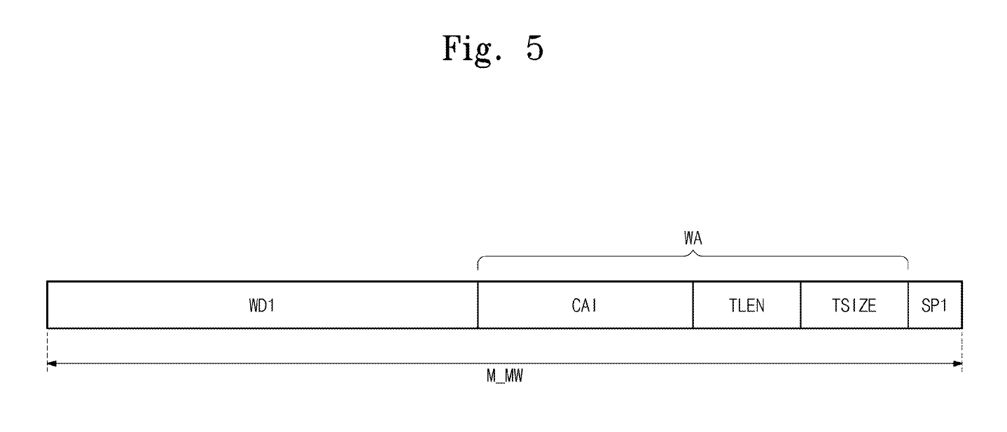

FIG. 5 is a diagram showing an exemplary configuration of data transferred via a merged write channel within the first burst in FIG. 3.

Referring to FIG. 5, a write address WA, the first write data WD1, and the first separator SP1 may be sent via a merged write channel M_MW. The merged write channel M_MW includes a plurality of wires through which a write address WA, the first write data WD1, and the first separator SP1 are sent. The first separator SP1 may be sent via a predetermined wire.

During the first burst T1, a write address WA may be sent via predetermined wires. During the second and third bursts T2 and T3 (refer to FIG. 3), only write data may be sent via predetermined wires since a write address WA is previously sent.

The write address WA includes Channel Alignment Information CAI, transfer length data TLEN, and transfer size data TSIZE.

In the AXI protocol based bus system, the channel alignment information CAI includes address information of a memory where write data is to be stored. In an exemplary embodiment, the channel alignment information CAI corresponds to a start address of a memory 250 (refer to FIG. 2) in which write data is to be stored.

The transfer length data TLEN indicates the number of bursts executed to transfer write data. For example, three bursts are needed to transfer write data in FIG. 3. In the case of FIG. 4, four bursts are needed to transfer write data. For example, it is assumed that the transfer length data TLEN is expressed by four bits. When a logical value of the transfer length data TLEN is ‘0000’, a burst is executed once to transfer write data. When a logical value of the transfer length data TLEN is ‘0010’, a burst is executed three times to transfer write data.

It is possible to adopt the merged write channel M_MW having the data width which is wider than the width of write data from the master 100. This means that masters with different write data widths can be connected to the bus. It is assumed that write data of 128 bits is transferred via the merged write channel M_MW within one burst. At this time, the write data width of the master 100 may be 64 bits wide.

The transfer size data TSIZE indicates a size of write data transferred from the master 100 during one burst. That is, the transfer size data TSIZE includes information on the write data width of the master 100.

According to an exemplary embodiment, a master bridge 120 (refer to FIG. 2) can transfer a write address WA and the first write data WD1 together within one burst, based on the write address WA. In addition, the master bridge 120 sends the first separator SP1 together in order to indicate a type of transferred data.

That is, the master bridge 120 may send a write address WA, the first write data WD1, and the first separator SP1, based on the transfer size data TSIZE included in the write address WA. A slave bridge 220 checks the first separator SP1 to determine whether transferred data is a write address WA and the first write data WD1.

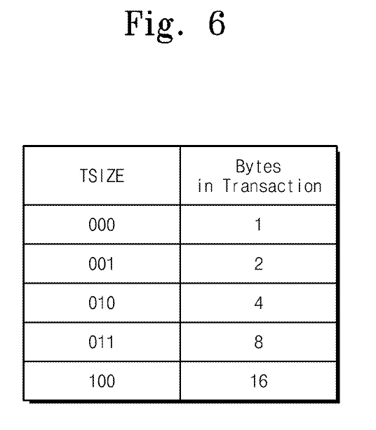

FIG. 6 is a table showing an example of a byte number of write data transferred during one burst when transfer size data is expressed by 3 bits.

Referring to FIG. 6, a byte number executed within one burst is determined according to a logical value of transfer size data TSIZE. It is assumed that a write data width of a bus 300 and a data width of respective merged write channels M_MW and S_MW are designed to be formed of 130 bits (a sum of 16 bytes and 2 bits).

Referring to FIG. 6, in the event that a logical value of transfer size data TSIZE is ‘000’, ‘001’, ‘010’, and ‘011’, a size of write data to be transferred may be 1, 2, 4, and 8 bytes, respectively. Accordingly, if a logical value of transfer size data TSIZE is ‘000’, ‘001’, ‘010’, and ‘011’, a size of write data to be transferred may be less than 130 bits.

It is assumed that a write address WA has an eight-byte size and that a separator has a 2-bit size. If a logical value of transfer size data TSIZE is ‘000’, ‘001’, ‘010’, and ‘011’, it is possible to transfer a write address WA, write data, and a separator within one burst. That is, the master bridge 120 may send a write address WA, write data, and a separator within one burst, based on transfer size data TSIZE.

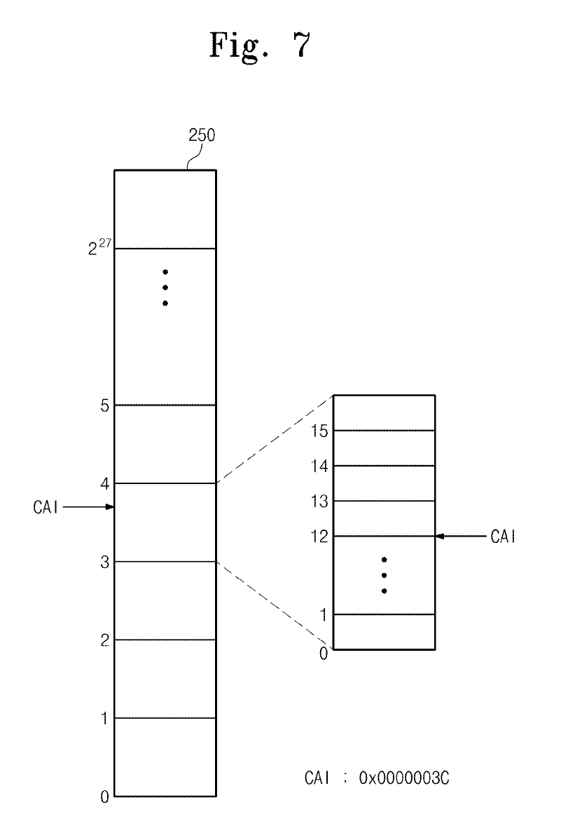

FIG. 7 is a diagram showing an example of an address region assigned to a memory in FIG. 2.

Referring to FIG. 7, a memory 250 may be divided into a plurality of regions each having a 16-byte size. That is, data corresponding to 16-type may be stored in each region.

As illustrated in FIG. 7, if the memory 250 is formed of 2²⁸ regions, it stores data corresponding 2³² bytes. The memory 250 can be accessed via a 32-bit address.

In the AXI protocol based bus system, channel alignment information CAI includes address information of the memory 250 where write data is to be stored. In FIG. 7, the channel alignment information CAI is illustrated to indicate the 12^{th} byte in the third region. For example, the channel alignment information CAI can be expressed by ‘0x0000003C’. In the channel alignment information CAI, ‘3’ indicates that a start address is included in the third region, and ‘C’ indicates that the 12^{th} byte of the third region is a start address where write data is to be stored.

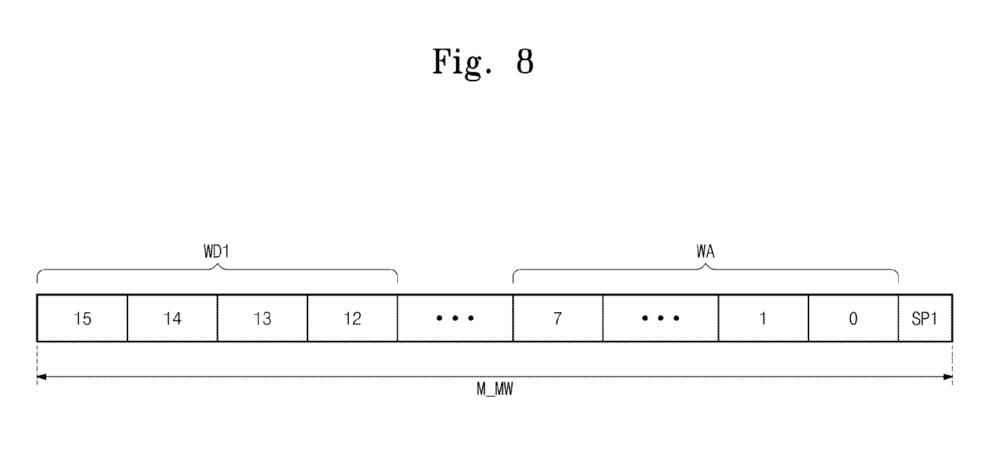

FIG. 8 is a diagram showing the case that the first write data and a write address are sent together during one burst according to channel alignment information of FIG. 7. FIG. 8 illustrates an example that a write address WA having an 8-byte (64-bit) size is transferred.

According to an exemplary embodiment, the first write data WD1 and a write address WA can be sent together within one burst even though the write data width of the master 100 is identical to that of the merged write channel M_MW. For example, a master bridge 120 (refer to FIG. 2) may determine whether the first write data WD1 and a write address WA are sent together, based on the channel alignment information CAI.

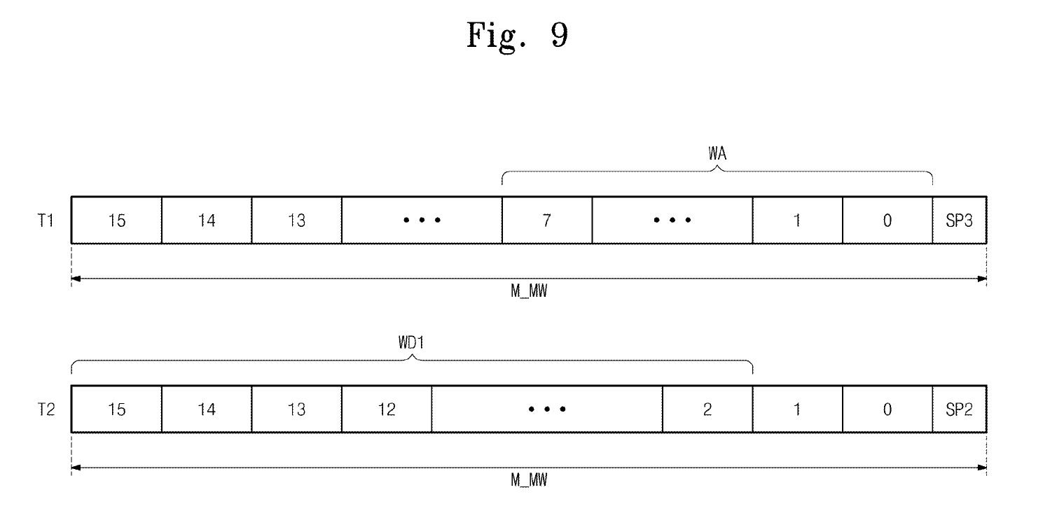

Below, the case that the write data width of the master 100 is identical to the data width of the merged write channel M_MW will be more fully described with reference to FIGS. 8 and 9.

Referring to FIG. 8, in a merged write channel M_MW, wires for transferring write data WD and a write address WA can be divided into plural byte lines. That is, the data width of the merged write channel M_MW may correspond to a sum of 16 bytes and a size of the first separator SP1. For example, the data width of the merged write channel M_MW may be 130 bits wide. In FIG. 8, there is illustrated an example that the first write data WD1 is transferred via the 12^{th} to 15^{th} byte lines and that a write address WA is transferred via the 0^{th} to 7^{th} byte lines.

Some of the byte lines may be determined as byte lines for transferring a write address WA. In FIG. 8, the 0^{th} to 7^{th} byte lines are determined as byte lines for transferring a write address WA. During the following bursts, byte lines for transferring a write address may be used to transfer write data.

In the AXI protocol based bus system 1000, the channel alignment information CAI may be determined based on an address of a memory 250 (FIG. 2) where write data is to be stored. In an exemplary embodiment, a master block 110 may generate the channel alignment information CAI of ‘0x0000003C’ in order to write data in the 12^{th} to 15^{th} bytes of the third region in the memory 250. That is, if a logical value of the CAI is ‘0x0000003C’, the CAI corresponds to the 12^{th} byte of the third region of the memory 250. At this time, the first write data WD1 is sent through the 12^{th} to 15^{th} byte lines. That is, in a case where data is written at the 12^{th} to 15^{th} bytes of the third region in the memory 250, the first write data WD1 is sent via the 12^{th} to 15^{th} byte lines. In this case, a write address WA may be transferred via the 0^{th} to 7^{th} byte lines. As a result, the master bridge 120 may send a write address WA and the first write data WD1 together within the first burst T1 (refer to FIG. 3).

It is assumed that data is written in the 12^{th} to 15^{th} bytes of the third region in the memory 250 and in the fourth and fifth regions. At this time, during the first burst T1, there is transferred data to be stored in the 12^{th} to 15^{th} bytes in the third region. Data to be stored in the fourth region is sent during the second burst T2, and data to be stored in the fifth region is sent during the second burst T3.

The master bridge 120 may determine an alignment degree of write data, based on the channel alignment information CAI. For example, write data is called “aligned” if it is sent via the 0^{th} byte line of the merged write channel M_MW. Write data is called “unaligned” if it is not sent via the 0^{th} byte line of the merged write channel M_MW. That is, it is possible to detect the alignment degree of write data transferred via the merged write channel M_MW, based on the channel alignment information CAI.

If aligned write data is sent, the master bridge 120 does not transfer a write address WA together with write data. On the other hand, if unaligned write data is sent, the master bridge 120 may determine whether a write address WA is sent together with write data WD1, based on the channel alignment information CAI.

That is, the master bridge 120 may transfer a write address WA, the first write data WD1, and the separator SP1 together during one burst, based on channel alignment information CAI included in a write address WA.

FIG. 9 is a diagram showing the case that a write address and the first write data are sent during two bursts, respectively.

In the event that the first write data WD1 and a write address WA are not transferred together, a master bridge 120 sends the write address WA in the first burst T1 and the first write data WD1 in the second burst T2.

For example, in the event that the first write data WD1 is written in the 2^{nd} to 15^{th} of the third region of a memory 250, a master block 110 may determine a logical value of channel alignment information CAI to be ‘0x00000032’. At this time, the master bridge 120 sends the first write data WD1 via the 2^{nd} to 15^{th} byte lines. If a write address WA has an 8-byte (or 64-bit) size, the first write data WD1 and the write address WA are not sent together. Accordingly, the master bridge 120 may send a write address WA and the third separator SP3 in the first burst T1. And, the master bridge 120 may send the first write data WD1 and the second separator SP2 in the second burst T2.

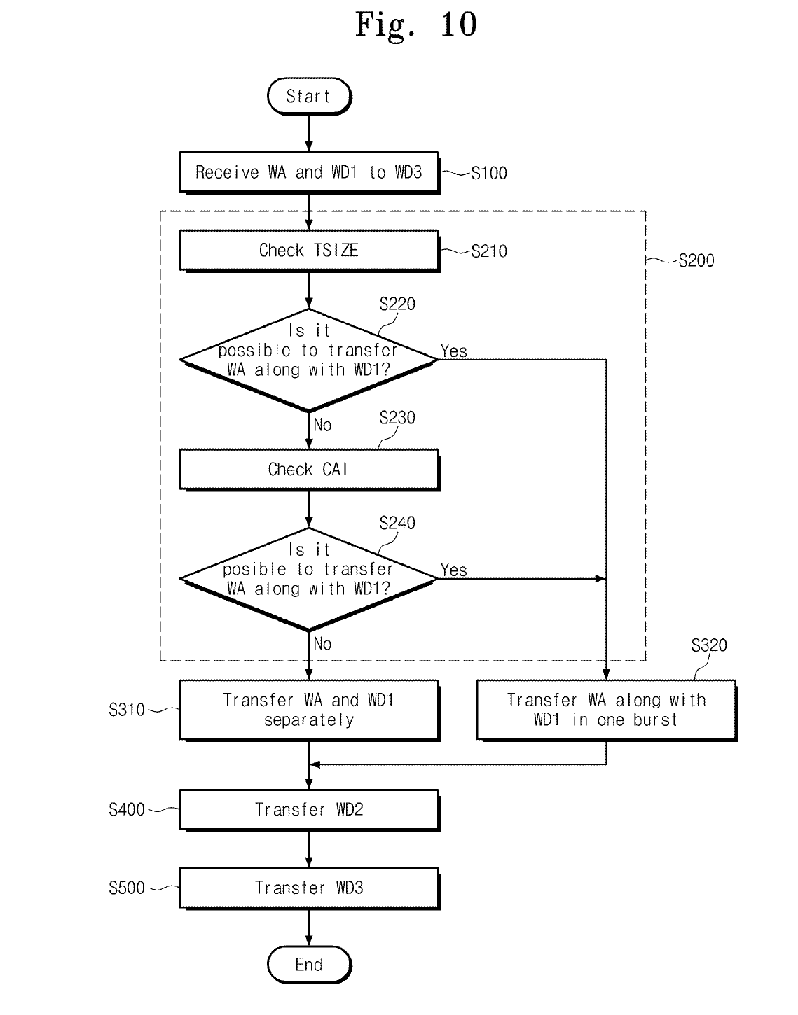

FIG. 10 is a flow chart for describing an operation where a write address and the first to third write data are transferred from a master bridge in FIG. 2. Referring to FIGS. 2 and 10, in operation S100, a master bridge 120 receives a write address WA and the first to third write data WD1 to WD3.

In operation S200, the master bridge 120 may determine whether the write address WA and the first write data WD1 can be sent together within one burst. Operation S200 includes operations S210 to S240.

In operation S210, the master bridge 120 checks transfer size data TSIZE. That is, the master bridge 120 may determine the write data width of the master block 110 based on the transfer size data TSIZE (refer to FIG. 5). In operation S220, the master bridge 120 determines whether the write address WA can be transferred with the first write data within one burst.

In a case where it is determined that the write address WA can be transferred with the first write data within one burst, the procedure goes to operation S320. In a case where it is determined that the write address WA can not be transferred with the first write data within one burst, the procedure goes to operation S230.

In operation S230, the master bridge 120 checks channel alignment information CAI. In operation S240, there is determined whether the write address WA can be transferred with the first write data WD1, based on the result of the checking If it is determined that the write address WA can be transferred with the first write data, the procedure goes to operation S320. If it is determined that the write address WA can not be transferred with the first write data, the procedure goes to operation S310.

In operation S310, the write address WA and the first write data WD1 are sent independently in different bursts. And, in respective bursts, there is sent a separator for discriminating transferred data.

In operation S320, the first write data WD1 and the write address WA are sent together within one burst. At this time, a separator is sent which is used to indicate that transferred data is write data and a write address. In operations S400 and S500, write data WD2 and WD3 are sent, respectively. In operation S400, the second data WD2 is sent with a separator indicating that transferred data is write data. And, in operation S500, the third data WD3 is sent with a separator indicating that transferred data is write data.

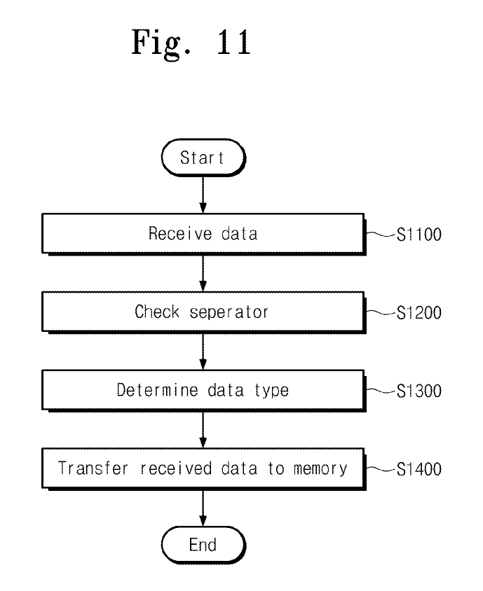

FIG. 11 is a flow chart for describing a method of receiving data via a slave bridge in FIG. 2.

Referring to FIG. 11, in operation S1100, a slave bridge 220 receives data via a merged write channel S_MW. In operation S1200, the slave bridge 220 checks a separator of the received data.

In operation S1300, the slave bridge 220 determines a type of the received data according to the checked separator. For example, as described with reference to FIGS. 3 to 9, the separator is formed of two bits. Whether both write address and write data are sent, whether only a write address is sent, and whether only write data is sent, may be determined according to the separator.

In operation S1400, the slave bridge 220 transfers the received data to a memory 250. For example, the slave bridge 220 and the memory 250 may be connected via a write address channel and a write data channel. When the received data is a write address, the slave bridge 220 may send a write address via the write address channel. When the received data is write data, the slave bridge 220 may send write data via the write data channel.

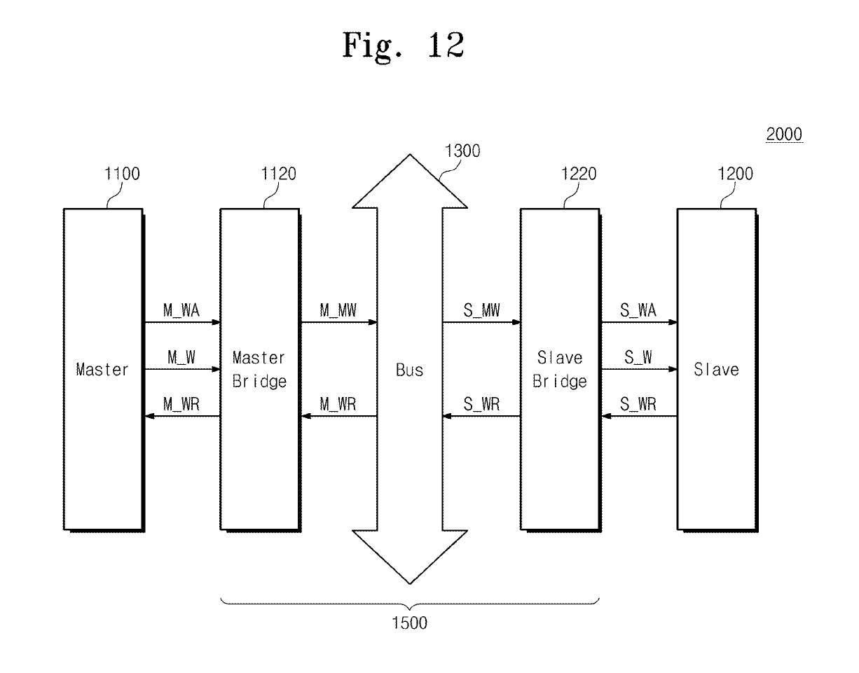

FIG. 12 is a block diagram showing a bus system according to the second embodiment.

A bus system 2000 in FIG. 12 is identical to the bus system 1000 in FIG. 1 except that a master bridge 1120 is provided outside a master 1100 and a slave bridge 1220 is provided outside a slave 1200, and description thereof is thus omitted.

The master 1100 is connected with the master bridge 1120 via a write address channel M_WA, a write data channel M_W, and a write response channel M_WR. The slave 1200 is connected with the slave bridge 1220 via a write address channel S_WA, a write data channel S_W, and a write response channel S_WR.

The master bridge 1120 is connected to a bus 1300 via a merged write channel M_MW and a write response channel M_WR. The slave bridge 1210 is connected to the bus 1300 via a merged write channel S_MW and a write response channel M_WR. The bus 1300 may be configured to be identical to that in FIG. 1.

The master bridge 1120, the slave bridge 1220, the merged write channels M_MW and S_MW, and the bus 1300 may constitute a combined interconnect 1500. The combined interconnect 1500 may provide a combined write channel for sending write data and a write address. That is, the merged write channel M_MW, the bus 1300, and the merged write channel S_MW are connected to constitute a combined write channel. The master bridge 1120 may transfer write data and a write address to the slave bridge 1220 via the combined write channel.

The bus 1300 may include a decoder (not shown). The decoder decodes a write address received from the master bridge 1120, and the bus 1300 connects the merged write channels M_MW and S_MW according to the decoded result.

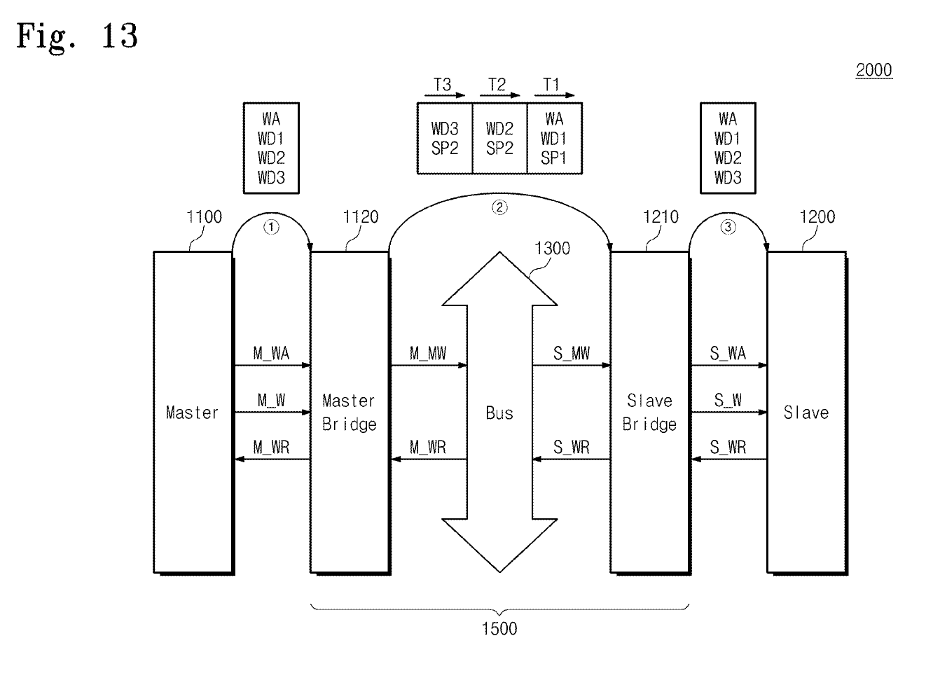

FIG. 13 is a diagram for describing an operation of transferring a write address and write data to a slave from a master in FIG. 12. Referring to FIG. 13, a write address WA and the first to third write data WD1 to WD3 are sent to a master bridge 1120 from a master 1100. At this time, the write address WA is sent via a write address channel M_WA. The write data WD1 to WD3 is transferred via a write data channel M_W.

The master bridge 1120 may determine whether the write address WA and the first write data WD1 can be transferred together within the first burst T1. If so, as illustrated in FIG. 13, the master bridge 1120 sends the write address WA and the first write data WD1 within the first burst T1. The master bridge 1120 sends the first separator SP1 for indicating a type of transferred data.

In the second burst T2, the master bridge 1120 sends the second write data WD2 and the second separator SP2 indicating that transferred data is write data. In the third burst T3, the master bridge 1120 sends the third write data WD3 and the second separator SP2 indicating that transferred data is write data.

The slave bridge 1220 receives data via a merged write channel S_MW. The slave bridge 1220 checks a separator included in received data and determines whether received data is a write address or write data, based on the checked separator.

The slave bridge 1220 sends a write address WA to the slave 1200 via the write address channel S_WA. The slave bridge 1220 transfers write data WD1 to WD3 to the slave 1200 via the write data channel S_W.

Although not shown in figures, the master 1100 may further include a master interface. The master 1100 may transfer a write address WA and write data WD1 to WD3 to the master bridge 1120 using the master interface (not shown). Likewise, although not shown in figures, the slave 1200 may further include a slave interface. The slave interface may receive a write address WA and write data WD1 to WD3 from the slave bridge 1220.

According to an exemplary embodiment, write data and a write address are sent to a slave from a master via a combined write channel passing merged write channels M_MW and S_MW and a bus. It is possible to improve the integration of a bus system as compared with the case of transferring write data and a write address via different channels.

In an exemplary embodiment, a write address and write data are sent to a slave from a master via the same channel. Therefore, the master does not generate identification information system as compared with the case of transferring write data and a write address via different channels. Accordingly, there is provided a bus system whose integration is improved.

The above-disclosed embodiments are illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A bus system comprising:
a master which is configured to transfer write data internally via a first write data channel and transfer an address internally via a first address channel;
a slave;
a bus which is configured to receive the write data and the address from the master and transfer the write data and the address received from the master to the slave via one channel.

2. The bus system of claim 1, wherein the master comprises:
a master block which is configured to generate the write data and the address; and
a master bridge which is configured to receive the write data from the master block via the first write data channel, receive the address from the master block via the first address channel, and transfer the write data and the address to the bus through the one channel.

3. The bus system of claim 1, wherein the slave internally transfers the write data received from the bus via a second write data channel and internally transfers an address received from the bus via a second address channel.

4. The bus system of claim 3, wherein the slave comprises:
a slave bridge which is configured to receive the write data and the address via the one channel; and
a slave block which is configured to receive the write data from the slave bridge via the second write data channel and receive the address from the slave bridge via the second address channel.

5. The bus system of claim 1, wherein the master further transfers a separator indicating whether transferred data is a combination of the address and the write data or is one of the address and the write data.

6. The bus system of claim 5, wherein the slave determines whether transferred data is the write data or the address, based on the separator.

7. The bus system of claim 1, wherein the slave stores the received write data at a region corresponding to the address.

8. The bus system of claim 1, wherein the write data and the address are transferred in a unit of a burst, and the master determines whether the write data and the address can be transferred together during one burst, based on a size of the write data.

9. The bus system of claim 8, wherein when the size of the write data and a size of the address are less than a data width of the one channel, the master determines that the write data and the address can be transferred together during one burst.

10. The bus system of claim 8, wherein the address includes information on a width of the write data, and the master determines whether the write data and the address can be transferred together within one burst based on the information on the width of the write data.

11. The bus system of claim 8, wherein the write data is transferred in a unit of a byte line, the one channel is formed of a plurality of byte lines, and the address includes information associated with byte lines for transferring the write data among the plurality of byte lines.

12. The bus system of claim 11, wherein the master determines whether the write data and the address can be transferred together within one burst, based on the address.

13. An operating method of a bus system including a master, a slave, and a bus connecting the master and slave, the operating method comprising:
receiving an address and write data to be sent to the slave from the master;
determining whether the address can be transferred with at least part of the write data;
if it is determined that the address can be transferred with the at least part of the write data, transferring the address and the part of the data together via a combined write channel; and
if it is determined that the address can not be transferred with the at least one part of the write data, transferring the address and the write data separately via the combined write channel.

14. The operating method of claim 13, further comprising transferring a separator indicating whether data transferred via the combined write channel is a combination of the address and the write data or is one of the address and the write data.

15. A bus system comprising:
a master which is configured to internally transfer write data and an address via a separate channels, and output the write data and the address;
a slave which is configured to receives the write data and the address output by the master, and internally transfer the write data and the address via separate channels; and
a bus which is configured to transfer the write data and the address output the master to the slave via a single integrated write channel.

16. The bus system of claim 15, wherein the master outputs the write data and the address in units of a burst, and the master outputs the address and at least a part of the write data together in a single burst via the single integrated write channel.

17. The bus system of claim 16, wherein the master outputs the address and the part of the write data together in a first burst via the single integrated write channel, and outputs a remaining part of the write data without the address in at least a second burst, subsequent to the first burst, via the single integrated channel.

18. The bus system of claim 17, wherein the master outputs a separator in each burst, and the separator indicates whether data in the burst is a combination of the address and the write data or is only one of the address and the write data.

19. The bus system of claim 18, wherein the slave determines whether transferred data is the write data or the address, based on the separator.

20. The bus system of claim 15, wherein the master outputs the write data and the address in units of a burst, and the master determines whether the write data and the address can be transferred together in a single burst, based on a size of the write data.
